(19) United States
(12) Patent Application Publication
(10) Pub. No.: US 2025/0269269 A1
(43) Pub. Date: Aug. 28, 2025

(54) HARDWARE APPARATUS WITH A SELF-RECALIBRATION MECHANISM AND METHOD FOR PERFORMING A SELF-RECALIBRATION IN A HARDWARE APPARATUS

(71) Applicant: Infineon Technologies AG, Neubiberg (DE)

(72) Inventors: Jakob VALTL, München (DE); Stephan LEISENHEIMER, Oberhaching (DE); Severin NEUNER, Valley (DE); Joo Il PARK, Sungnam-Si (KR)

(21) Appl. No.: 19/062,777

(22) Filed: Feb. 25, 2025

(30) Foreign Application Priority Data
Feb. 27, 2024 (DE) 102024201809.0

(51) Int. Cl. A63F 13/22

(52) U.S. Cl. CPC A63F 13/22

(57) ABSTRACT

The present disclosure concerns a hardware apparatus with a self-recalibration mechanism, the hardware apparatus including a movable mechanical operating element configured to be moved by a user within a predetermined mechanical movement range, and a sensor device for determining a position of the operating element within its predetermined mechanical movement range. The sensor device is configured to perform a self-recalibration by determining a mechanical zero position of the operating element in its non-actuated state, and by setting a Zero Position Zone extending around the mechanical zero position. The sensor device is configured to treat all positions of the operating element that are located inside the Zero Position Zone as virtual zero positions.

### CROSS-REFERENCE TO RELATED APPLICATION

This application claims priority to Germany Patent Application No. 102024201809.0 filed on Feb. 27, 2024, the content of which is incorporated by reference herein in its entirety.

### FIELD

Implementations of the present disclosure relate to a hardware apparatus having an operating element, such as a game controller having a joystick, a drilling machine having a push button, and the like. The hardware device is capable of self-reconfiguring a zero position of the operating element. Further implementations concern a corresponding method for performing a self-recalibration in a hardware apparatus.

### BACKGROUND

Electric and electronic hardware apparatuses are equipped with operating elements that are used to operate the hardware apparatus. For example, game controllers may be equipped with movable joysticks that may also be referred to as analog sticks. A user may actuate the analog stick of the game controller in order to control a game play character in a video game. A further example would be an electric tool. Electric tools may be equipped with push buttons for operating the tool. For example, the further a user pushes the push button, the faster the electric tool moves.

Operating elements need to be calibrated prior to its first use in order to initially define the zero position of the operating element. Only when the zero position is properly defined, the operating element may register an actuated state, in which the operating element is deflected from its zero position, such as a movement of an analog stick during game play. A factory calibration may be done in the fabric before the hardware apparatus is delivered. However, during normal use of the hardware apparatus, the initially calibrated zero position may change. This may be caused, for instance, by mechanical hysteresis, by sensor noise or by signal offsets.

For example, if an analog stick was previously deflected to an upper left corner, it will return to a different zero position than if it was previously deflected to a lower right corner. This may be caused by hysteresis. As a further example, it may happen that the game controller falls to the ground and hits the floor hard. In this case, the analog stick's mechanics inside the game controller may be shifted and become relocated, such that the zero position changes.

If the previously calibrated zero position has changed, then it may happen that an unactuated state of the operating element may be wrongly interpreted as an actuated state leading to the consequence that the hardware apparatus is active even though it is not operated. For example, if a drilling machine is running even though it is not operated by a user, this may lead to serious injuries.

Thus, a change in the previously calibrated zero position may lead to the need for a recalibration of the operating element outside the factory, e.g., at a user's site. For example, a user may manually re-adjust a the zero point of a drilling machine. For this purpose, drilling machines offer small rotating wheels being integrated in the push button (trigger). In video games, the user may start a specific controller calibration menu, in which he is guided through a predetermined re-calibration procedure. However, these conventional recalibration processes have to be performed manually, which may be time consuming and annoying for a user, in particular if the recalibration process has to be performed in regular time intervals.

Therefore, it is an object of the herein described innovative concept to provide a hardware apparatus that reduces or even eliminates the need for a manual recalibration of the operating element. It is a further object to provide a hardware apparatus that is capable of automatically recalibrate the operating element without any user involvement.

### SUMMARY

This goal is achieved using the herein disclosed hardware apparatus and the corresponding method for performing a self-recalibration of the hardware apparatus according to the independent claims. Further implementations and advantageous aspects are suggested in the dependent claims.

The innovative hardware apparatus includes a movable mechanical operating element configured to be moved by a user within a predetermined mechanical movement range, and a sensor device configured to determine a position of the operating element within its predetermined mechanical movement range. The sensor device is configured to perform a self-recalibration by determining a mechanical zero position of the operating element in its non-operated state, and by setting a Zero Position Zone extending around the mechanical zero position, wherein the sensor device is configured to treat all positions of the operating element being located inside the Zero Position Zone as virtual zero positions.

Furthermore, an innovative method for performing a self-recalibration of a hardware device is suggested, the method including a step of determining a position of an operating element that is movable by a user within a predetermined mechanical movement range. The method further includes a step of performing the self-recalibration by determining a mechanical zero position of the operating element in its non-operated state, and by setting a Zero Position Zone extending around the mechanical zero position, wherein all positions of the operating element being located inside the Zero Position Zone are treated as virtual zero positions.

According to a further aspect, computer programs are provided, wherein each of the computer programs is configured to implement the above-described method when being executed on a computer or signal processor, so that the above-described method is implemented by one of the computer programs.

### BRIEF DESCRIPTION OF THE DRAWINGS

In the following, implementations of the present disclosure are described in more detail with reference to the figures, in which

FIG. 1 shows an illustrative drawing of a game controller as a non-limiting example of an innovative hardware apparatus.

FIG. 2 shows a schematic representation of a two-dimensional total mechanical movement range of an operating element, wherein a current actual position of an operating element is located in the center.

FIG. 3 shows a schematic representation of a two-dimensional total mechanical movement range of an operating element, wherein a current actual position of an operating element is located off-center.

FIG. 4 shows a schematic representation of an innovative Zero Position Zone, wherein a mechanical zero position of an operating element defines the center of the Zero Position Zone.

FIG. 5 shows a schematic representation of different mechanical zero positions caused by hysteresis when the operating element returns from different deflected positions.

FIG. 6A shows a schematic representation of a two-dimensional total mechanical movement range of an operating element, wherein two differently sized initial Zero Position Zones are depicted.

FIG. 6B shows a schematic representation of a two-dimensional total mechanical movement range of an operating element, wherein a decreased Zero Position Zone is depicted.

FIG. 7 shows a schematic block diagram of an innovative method.

FIG. 8 shows a schematic flow chart of an innovative method.

FIG. 9 shows a schematic representation of a two-dimensional total mechanical movement range of an operating element, wherein a current actual position of an operating element lies outside a decreased Zero Position Zone.

FIG. 10 shows a schematic representation of a two-dimensional total mechanical movement range of an operating element, wherein a minimized Zero Position Zone is created using a plurality of Zero Position Zones.

FIG. 11 shows a schematic representation of a one-dimensional total mechanical movement range of an operating element.

### DETAILED DESCRIPTION

Equal or equivalent elements or elements with equal or equivalent functionality are denoted in the following description by equal or equivalent reference numerals.

Method steps which are depicted using a block diagram and which are described with reference to the block diagram may also be executed in an order different from the depicted and/or described order. Furthermore, method steps concerning a particular feature of a device may be replaceable with the feature of the device, and the other way around.

For ease of explanation, the following discussion exemplarily refers to a game controller as a non-limiting example of an innovative hardware apparatus, and to an analog stick as a non-limiting example of an innovative operating element. However, the innovative concept can be employed in a variety of different hardware apparatuses in which an operating element can be positioned in a mechanical zero position, and be deflected from the mechanical zero position, in order to operate the hardware apparatus.

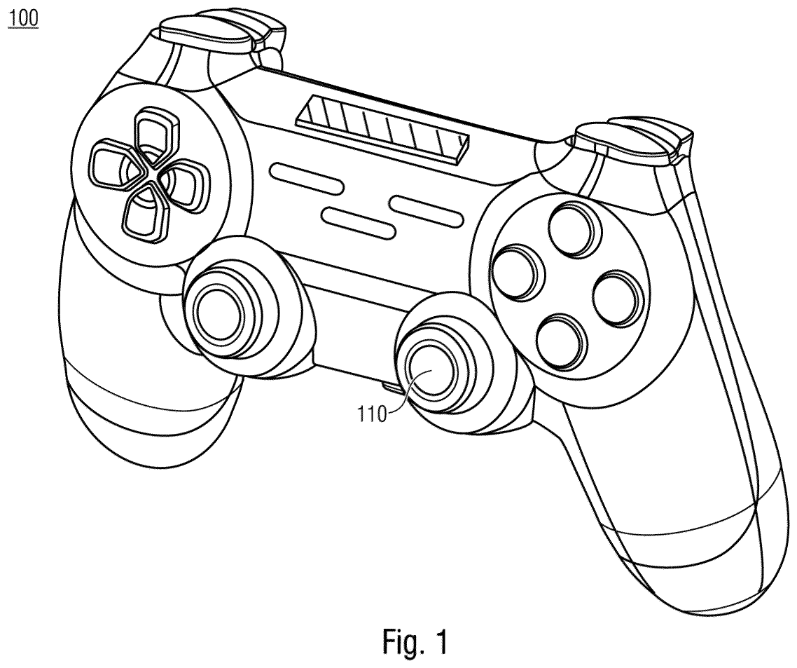

FIG. 1 shows a game controller as a non-limiting example of a hardware apparatus 100 comprising an innovative self-recalibration mechanism. The hardware apparatus 100 may comprise a movable mechanical operating element 110 configured to be moved by a user within a predetermined mechanical movement range. For example, the mechanical operating element 110 may be an analog stick mounted at the game controller 100. The analog stick 110 may be deflected/moved into different directions in order to control a game play character in a video game. However, the analog stick 110 may only be moved within a predetermined movement range that is constituted by mechanical restrictions.

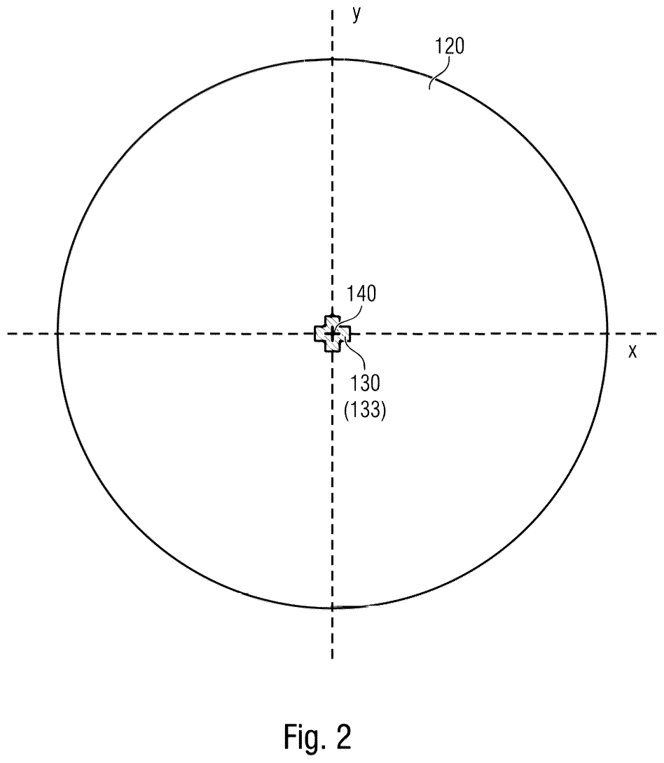

FIG. 2 shows a schematic representation of a possible mechanical movement range 120 of an operating element 110. In this example, the movement range 120 is two-dimensional comprising a circular area spanned in an x-y-plane. The cross 130 indicates a raw position of the operating element 110. The raw position 130 corresponds to a current actual position of the operating element 110. The current actual position 130 may be indicated with raw measurement values, for example with x- and y-coordinates.

In order to determine a current actual position 130 of the operating element 110, the hardware element 100 may comprise a sensor device (not depicted). The sensor device 110 may be configured to determine the current actual position 130 of the operating element 110 in any actuated and non-actuated state.

For example, when the operating element 110 is operated by being moved/deflected, it is an actuated state. In turn, if the operating element 110 is not moved/deflected, it is in a non-actuated state. When the operating element 110 is in a non-actuated state, the current actual position 130 of the operating element 110 defines its mechanical zero position 133.

FIG. 1 shows the operating element 100 in a non-actuated state, e.g., in its mechanical zero position. When the operating element 110 is released from an actuated state to a non-actuated state, it may automatically return to its mechanical zero position. For example, the operating element 100 may comprise a mechanical biasing mechanism that is configured to mechanically move the operating element 110 from an actuated position back to its mechanical zero position.

Returning to FIG. 2, the aforementioned sensor device for determining the current actual position 130 of the operating element 110 may be pre-calibrated, wherein a certain mechanical zero position 133 of the operating element 110 may be stored as a calibrated zero position. In this case, the calibrated zero position is the same as the mechanical zero position 133. Ideally, the calibrated zero position is located in the center 140 of the operating element's total movement range 120.

After the calibrated zero position has been set, the operating element 110 may again be actuated and may again return from any actuated state into a non-actuated state. However, due to hysteresis effects or mechanical degradation, it may happen that now the mechanical zero position 133 is not the same as the calibrated zero position anymore. It may also be possible that the sensor device itself suffers from sensor drift such that the calibrated mechanical zero position drifts away from its initial value.

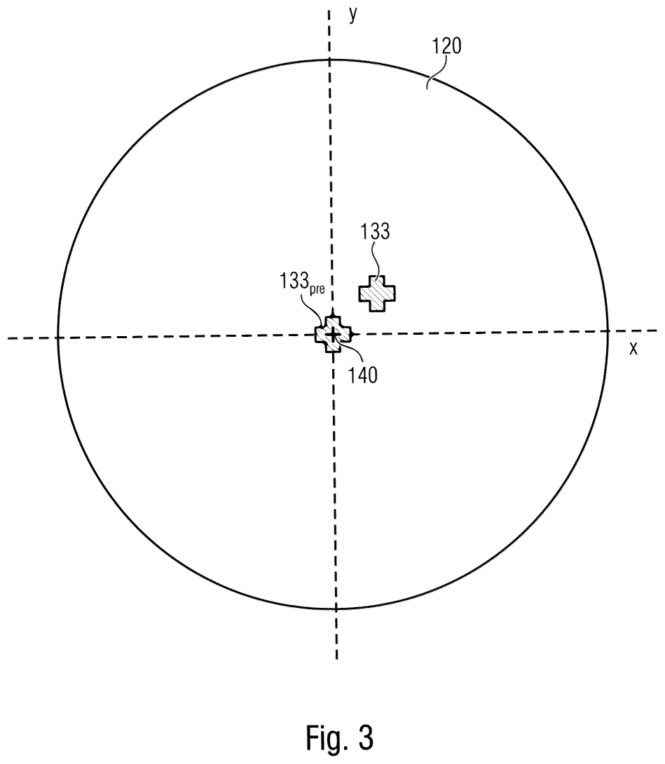

FIG. 3, shows a scenario in which the mechanical zero position 133 of the operating element 110 (in its non-actuated state) deviates from the previously defined calibrated zero position, indicated with reference numeral 133ₚᵣₑ. Such deviations may happen due to mechanical abrasion/degradation, hysteresis effects, sensor drifts or signal offsets. In such cases, a recalibration of the operating element 110 may be necessary. The innovative sensor device may perform an automated self-recalibration.

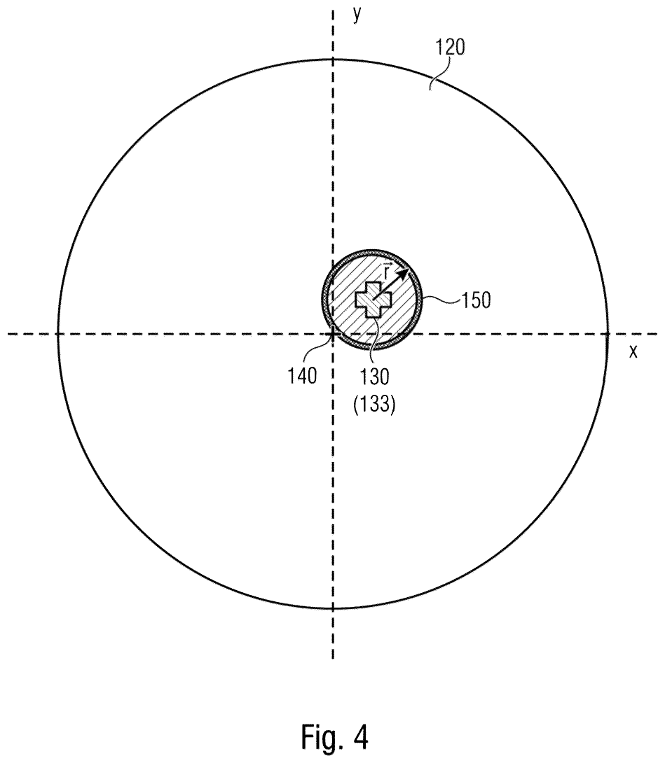

FIG. 4 shows an implementation of the innovative concept for an automated self-recalibration. When the operating element 110 is in its non-actuated state, the sensor device may set the related current actual position 130 of the operating element 110 as its mechanical zero position 133. Accordingly, this mechanical zero position 133 now is a calibrated zero position. In a further calibration step, the sensor device may set a Zero Position Zone 150 that extends around the calibrated mechanical zero position 133. According to the innovative concept, the sensor device is configured to treat all current actual positions 130 of the operating element 110 that are located inside the Zero Position Zone 150 as virtual zero positions.

Accordingly, a plurality of different current actual positions 130 of the operating element 110 may be considered as zero positions, as long as they are located inside the previously defined Zero Position Zone 150. In other words, common manual recalibration mechanisms use a single zero value for defining a calibrated zero position. The innovative concept instead replaces the single zero value by a Zero Position Zone 150 in which a plurality of different current actual positions 130 of the operating element 110 may be considered a zero position. Therefore, these zero positions are referred to as virtual zero positions in the present disclosure.

As exemplarily depicted in FIG. 4, the sensor device may perform the self-recalibration by determining a mechanical zero position 130 of the operating element 110 in its non-actuated state. As described above, when the operating element 110 is in a non-actuated state, its current actual position 130 may be set as its mechanical zero position 133. The mechanical zero position 133 now is a calibrated zero position. In a further calibration step, the sensor device may set a Zero Position Zone 150 extending around the calibrated mechanical zero position 133, so that the calibrated mechanical zero position 130 defines the center of the Zero Position Zone 150.

The Zero Position Zone 150 may be defined as a circular area with radius ‘r’ extending around the mechanical zero position 130. According to the innovative concept, the sensor device is configured to treat all mechanical positions of the operating element 110 that are located inside the Zero Position Zone 150 as virtual zero positions.

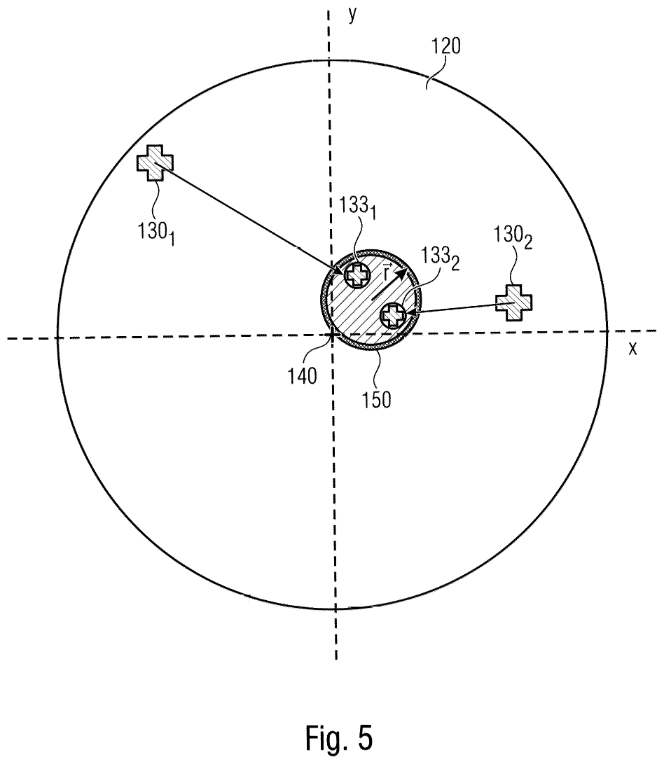

FIG. 5 shows a schematic representation, wherein the operating element 110 returns from different actuated states to different non-actuated states. For example, the operating element 110 may be actuated/deflected into a first actual position 130₁ in the upper left corner, and subsequently into a second actual position 130₂ in a lower right corner. As mentioned above, when the operating element 110 is released into its non-actuated state, it may automatically return into its mechanical zero position 133. However, due to hysteresis effects and the like, the operating element 110 may return to different mechanical zero positions.

As exemplarily depicted, when the operating element 110 is released from its first actual position 130₁, it may return to a first mechanical zero position 133₁. In turn, when the operating element 110 is released from its second actual position 130₂, it may return to a different second mechanical zero position 133₂. Thus, there are two different mechanical zero positions 133₁, 133₂ that may, in addition, deviate from a previously set calibrated zero position. Thus, a common sensor device may not know whether both mechanical zero positions 133₁, 133₂ are to be treated as zero positions.

According to the innovative concept, however, all positions of the operating element 110 that are located inside the Zero Position Zone 150 will be treated by the sensor device as virtual zero positions.

As mentioned above, the Zero Position Zone 150 may be defined as a circular area with radius ‘r’, wherein the radius ‘r’ may define the size of the Zero Position Zone 150. The size of the Zero Position Zone 150 may be set to a fixed value, or it may be dynamically adjusted, as will be explained in more detail below. The size may be selected such that different mechanical zero positions 133₁, 133₂ of the operating element 110 that suffer from position deviations being caused by at least one of hysteresis, noise or offsets, may be covered.

For example, the sensor device may be configured to set a size of the Zero Position Zone 150 to a fixed value that covers all non-actuated states of the operating element 110 even despite position deviations being caused by at least one of hysteresis, noise and signal offsets. The radius ‘r’ of the Zero Position Zone 150 may be chosen so large that the operating element 110 always falls into the Zero Position Zone 150 when the operating element 110 is released, irrespective from which actuated position 130₁, 130₂ it is released and from which actuated position 130₁, 130₂ it returns into its mechanical zero position 133₁, 133₂, e.g., any possible zero position deviations are considered when choosing the radius ‘r’. Accordingly, the innovative concept provides for an automated self-recalibration that accounts for zero position deviations caused by at least one of hysteresis, sensor noise and signal offsets.

On the other hand, it is desirable to make the size of the Zero Position Zone 150 as small as possible, because otherwise the user may experience an undesired behavior of the operating element 110. For example, if a size of the Zero Position Zone 150 is chosen too large, then the user must deflect the operating element 110 a long way in order to leave the Zero Position Zone 150 where the sensor device recognizes a non-zero actuated state. In real life, for instance, the user has to deflect the operating element 110 a long way before the game play character starts moving in the video game.

The authors of the present disclosure found that a size of 2% to 8%, and in particular around 5%, of the total movement range 120 of the operating element 110 provide for a good trade-off between a large enough Zero Position Zone 150 that covers all possible zero position deviations (caused by hysteresis, etc.) and a small enough Zero Position Zone 150 that ensures a good haptic for the user. Thus, according to an implementation, the sensor device may be configured to set a size of the Zero Position Zone 150 to a fixed value that covers between 2% to 8%, and in particular 5%, of the total movement range 120 of the operating element 110.

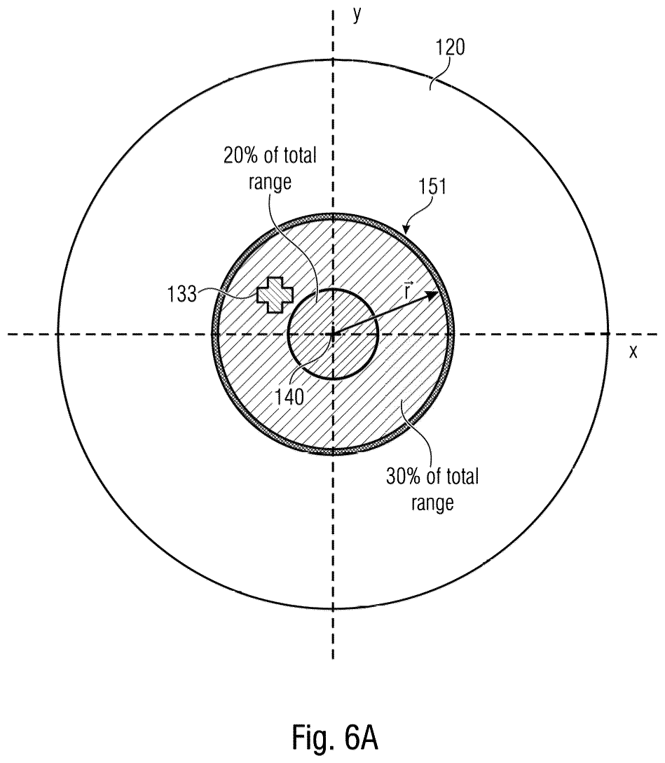

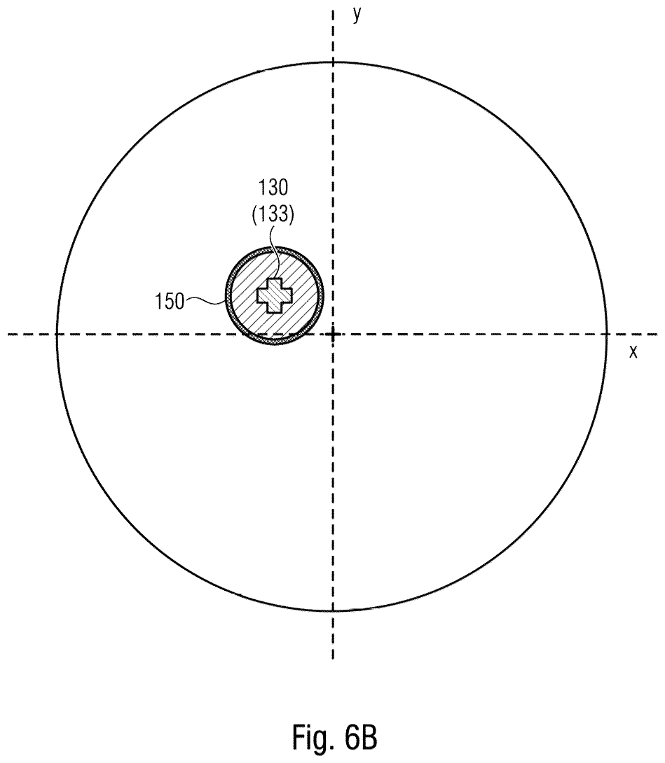

Since the mechanical zero positions 133₁, 133₂ of the operating element 110 may not be known in advance, an initial calibration step may be performed by the sensor device. As shown in FIG. 6A, the sensor device may set an initial Zero Position Zone 151 that is larger than the previously discussed Zero Position Zone 150, wherein the size of the initial Zero Position Zone 151 is chosen so as to be large enough to cover a wide area in which a majority (or even all) possible mechanical zero positions 133₁, 133₂ of the operating element 110 may be located.

FIG. 6A shows an example for an initial calibration step, wherein the sensor device may set a size (defined by radius ‘r’) of the initial Zero Position Zone 151 to a fixed value that covers between 20% to 30% of the total movement range 120 of the operating element 110. The initial Zero Position Zone 151 may be positioned in the center 140 of the operating element's total movement range 120.

As exemplarily depicted in FIG. 6A, a mechanical zero position 133 of the operating element 110 (in its non-actuated state) may be located outside an initial Zero Position Zone 151 having a size of 20% of the operating element's total movement range 120, but it may be located inside an initial Zero Position Zone 151 having a size of 30% of the operating element's total movement range 120. The authors of the present disclosure found that a size of approximately 25% of the operating element's total movement range 120 may suffice to cover nearly all possible mechanical zero positions 133 of the operating element 110 occurring in all four quadrants.

As shown in FIG. 6B, after the initial calibration step (FIG. 6A), the sensor device may fine-tune the self-recalibration mechanism by creating a new or an updated version of the Zero Position Zone with a decreased size. For example, after the initial calibration step, the sensor device may perform a subsequent calibration step in which a current actual position 130 of the operating element 110 in its non-actuated state is set as a new mechanical zero position 133. The new mechanical zero position 133 defines a center of a new decreased Zero Position Zone 150, wherein the decreased Zero Position Zone 150 is smaller than the previous initial Zero Position Zone 151.

In this case, the decreased Zero Position Zone 150 may correspond to the above discussed Zero Position Zone 150. Accordingly, everything that has been discussed so far with respect to any Zero Position Zones also holds for the decreased Zero Position Zone 150.

In particular, the sensor device may set a size of the decreased Zero Position Zone 150 to a fixed value that covers different mechanical zero positions 1331, 1332 of the operating element 110 with position deviations being caused by at least one of hysteresis, noise or offsets. As mentioned above, a size between 2% to 8%, and in particular approximately 5%, of the operating element's total movement range 120 provides for a good trade-off between a large enough Zero Position Zone 150 that covers all possible zero position deviations (caused by hysteresis, etc.) and a small enough Zero Position Zone 150 that ensures a good haptic for the user.

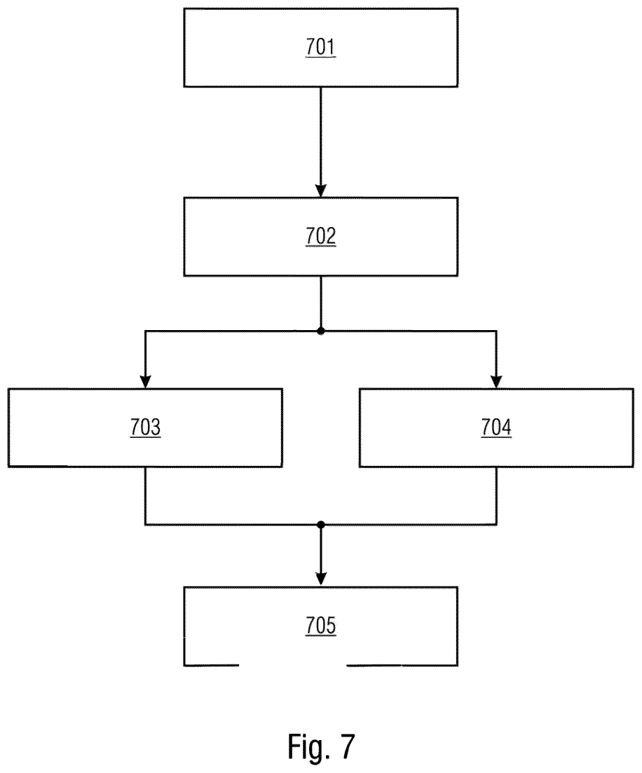

FIG. 7 shows a block diagram of a method 700 for performing the innovative self-recalibration in a hardware apparatus according to an implementation.

In block 701, a position of an operating element 110 is determined, wherein the operating element 110 is movable by a user within a predetermined mechanical movement range 120.

In block 702, the self-recalibration may be executed by performing two steps. Block 703 shows a first step, in which a current actual position 130 of the operating element 110 in its non-actuated state is set as a mechanical zero position 133. Block 704 shows a second step, in which a Zero Position Zone 150 is set that extends around the mechanical zero position 133. The steps of blocks 703 and 704 may be performed in parallel or sequentially.

Block 705 represents the final step after performing the self-calibration, wherein all positions of the operating element 110 being located inside the Zero Position Zone 150 are treated as virtual zero positions.

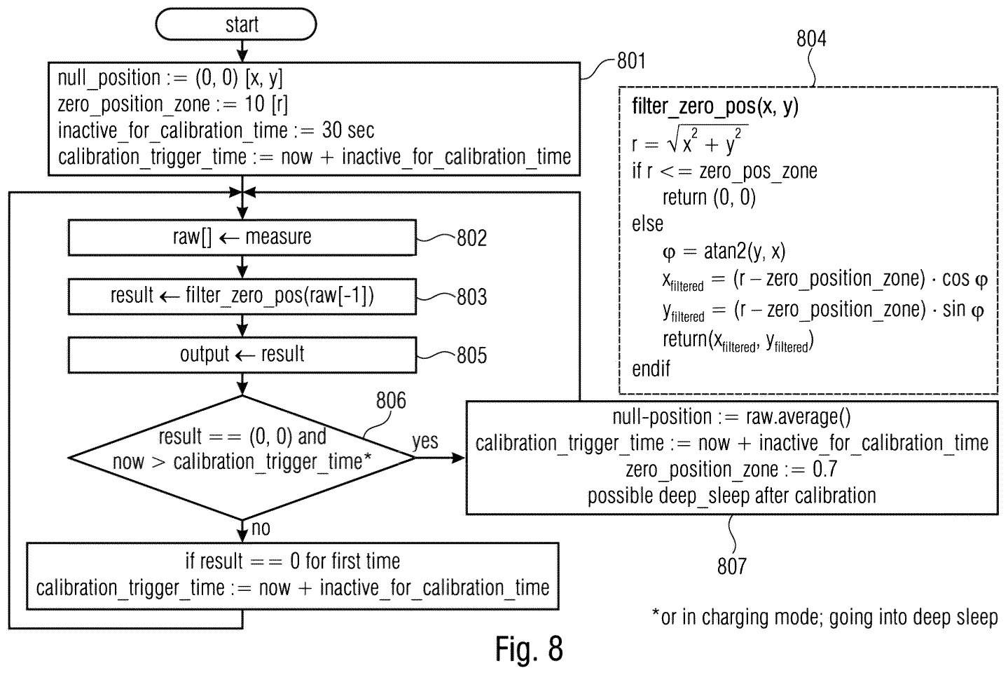

FIG. 8 shows an example flow chart of a non-limiting possible implementation of the innovative concept.

Block 801 represents the above discussed initial calibration step. The center 140 of the operating element's total movement range 120 (FIG. 2) is set as an initial mechanical zero position “null_position”. An initial Zero Position Zone 151 (FIG. 6A) is set with a size having a fixed value, for instance r=10. As discussed above, the size of the initial Zero Position Zone 151 is selected to be rather large (e.g., between 20% and 30% of the total movement range 120) in order to cover a majority of possible mechanical zero positions 133₁, 133₂ of the operating element 110.

In this example implementation, the sensor device may further be configured to wait for the lapse of a predetermined period of time (inactive_for_calibration_time) during which the operating element 110 is in a non-actuated state, in order to make sure that the operating element 110 is indeed in a non-actuated state, before performing the self-recalibration. For example, if the operating element 110 is not actuated for a certain period of time, e.g., for 30 seconds or more, this may indicate that the operating element 110 is currently not in use and, thus, the self-recalibration may begin.

Additionally or alternatively, the sensor device 110 may be configured to wait for the occurrence of a predetermined event (e.g., operating element 110 in charging mode or going into deep sleep) indicating that the operating element 110 is in a non-actuated state before performing the self-recalibration.

In block 802 a current actual position 130 of the operating element 110 may be determined. A current actual position 130 of the operating element 110 may be represented by raw measurement values taken by the sensor device, as discussed above. For example, a current actual position 130 of the operating element 110 may be indicated by a coordinate, e.g., by at least one of an x- and y-coordinate.

In block 803 it may be determined whether the previously determined current actual position 130 of the operating element 110 is located inside or outside the initial Zero Position Zone 151. For example, a function (filter_zero_pos(x,y)) may be called, in which x- and y-coordinates (representing the current actual position 130 of the operating element 110) are passed as arguments.

Block 804 shows a possible implementation of the function filter_zero_pos(x,y). First, the sensor device may check whether a current actual position 130 (defined by the arguments (x,y)) of the operating element 110 is located inside the initial Zero Position Zone 151. The sensor device may perform the check by determining a radial distance ‘r’ of the operating element's current actual position 130 from the center 140 of the operating element's total movement range 120 (e.g., r=\sqrt{x²+y²}). The sensor device may further be configured to check whether the radial distance ‘r’ is less than or equal to the radius of the initial Zero Position Zone 151.

If the sensor device determines that the current actual position 130 of the operating element 110 is located inside, or at a margin of, the initial Zero Position Zone 151 (r<=zero_pos_zone), then the sensor device may treat the current actual position 130 of the operating element 110 as a virtual zero position (return (0,0)). In other words, all current actual positions 130 of the operating element 110 that are located inside (or at a margin of) the Zero Position Zone 150, 151 are considered as zero positions.

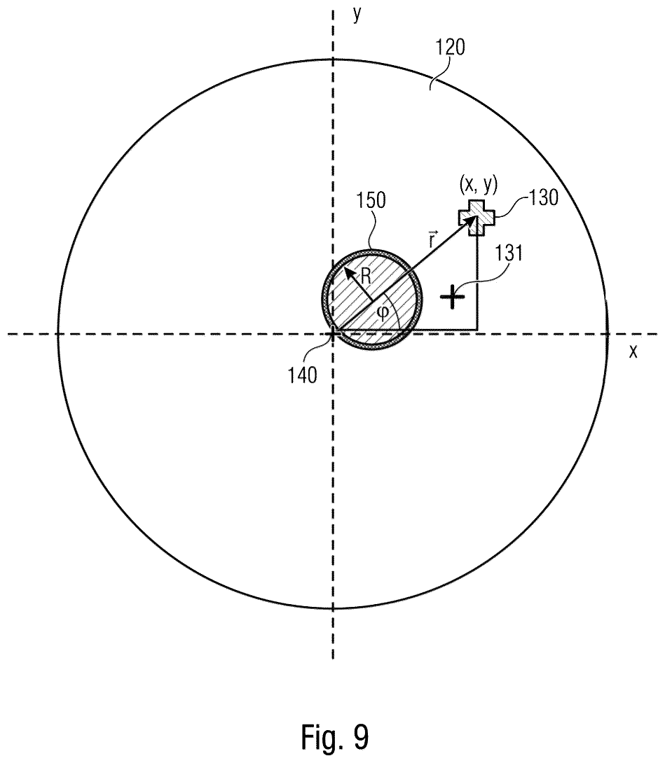

In turn, if the sensor device determines that the current actual position 130 of the operating element 110 is located outside the initial Zero Position Zone 151 (else-branch in block 804), then the sensor device may be configured to subtract the radius of the initial Zero Position Zone 151 from the actual current position 130 of the operating element 110, such that the beginning of a movement of the operating element 110 is only registered when the operating element 110 leaves the initial Zero Position Zone 151. This shall be briefly explained in more detail with reference to FIG. 9.

FIG. 9 shows a schematic illustration for the above concept. It is to be noted that, in this non-limiting example, a random Zero Position Zone 150 is depicted instead of the above discussed initial Zero Position Zone 151. However, the innovative concept can be performed on both the initial Zero Position Zone 151 and any other Zero Position Zones 150.

Here in FIG. 9, a decreased Zero Position Zone 150 with radius ‘R’ is exemplarily depicted. Furthermore, a current actual position 130 of the operating element 110 is represented by a certain x-y-coordinate (x,y). As can already be seen, the current actual position 130 of the operating element 110 is located outside the Zero Position Zone 150. This means, the operating element 110 is deflected, e.g., it is in an actuated state.

According to the present innovative concept, each current actual position 130 of the operating element 110 that is not considered a (virtual) zero position is considered a deflected position. In other words, if a current actual position 130 of the operating element 110 is located outside the Zero Position Zone 150, 151, then this current actual position 130 is considered a deflected position, e.g., the operating element 110 is in an actuated state.

As shown in the else-branch of block 804 (FIG. 8), the sensor device may be configured to calculate an angle φ between the x-axis and the vector r (spanned between the center 140 and the current actual position 130).

Furthermore, the sensor device may subtract the radius ‘R’ of the Zero Position Zone 150 from the current actual position 130 of the operating element 110. In particular, the sensor device may subtract the radius ‘R’ (zero_position_zone) of the Zero Position Zone 150 from the x-coordinate belonging to the current actual position 130 of the operating element 110 (x_{filtered}=(r−zero_position_zone) cos φ), and subtract the radius ‘R’ (zero_position_zone) of the Zero Position Zone 150 from the y-coordinate belonging to the current actual position 130 of the operating element 110 (y_{filtered}=(r−zero_position_zone) sin φ).

By doing so, the sensor device may start calculating the current actual position 130 of the operating element 110 from the margin of the Zero Position Zone 150, instead of from the center 140 of the operating element's total movement range 120. In other words, the sensor device registers an actuated state of the operating element 110 only from that moment, when the operating element 110 leaves the Zero Position Zone 150, 151. Accordingly, a soft transfer between a non-actuated state (inside the Zero Position Zone) and an actuated state (outside the Zero Position Zone) can be realized.

For example, a random current actual position 131 being exemplarily depicted in FIG. 9, is located outside the Zero Position Zone 150, e.g., it is considered an actuated state of the operating element 110. The current actual position 131 is spaced apart from the mechanical center 140 by almost half the entire way along the x-axis. When the operating element 110, e.g., an analog stick of a game controller, is deflected up to this position, then a game play character would run at almost half its speed. However, since all positions lying inside the Zero Position Zone 150 are considered virtual zero positions, an abrupt transition would occur when the operating element 110 leaves the Zero position Zone 150. In other words, the game play character would abruptly start to run instead of slowly walk.

However, according to the present innovation, the radius of the Zero Position Zone 150 is subtracted from the current actual position 131 such that the beginning of the actuated state of the operating element 110 is shifted by the size of the Zero Position Zone 150. Thus, the beginning of a movement of the operating element 110 is only registered when the operating element 110 leaves the Zero Position Zone 150. Accordingly, the game play character smoothly begins to run from that moment on when the operating element 110 leaves the Zero Position Zone. There is no abrupt transition anymore. One can say, the x-, y-coordinates belonging to the current actual position 131 are filtered by taking into account the size of the Zero Position Zone 150.

Returning to FIG. 8, in block 804, the above discussed function filter_zero_pos(x,y) returns the filtered x-, y-coordinates labeled as x_{filtered} and y_{filtered}. The innovative self-recalibration process then proceeds with block 805, in which the result is output. The result is either a virtual zero position (0,0) if the operating element 110 is located inside the Zero Position Zone 150, or the above discussed filtered x-, y-coordinates x_{filtered} and y_{filtered}.

Remember, the above description of FIG. 8 still refers to the initial calibration step using the initial Zero Position Zone 151. So, block 806 includes a query for determining whether the current actual position 130 of the operating element 110 is located inside the initial Zero Position Zone 151. If so, a decreased Zero Position Zone 150 is created that comprises a decreased size compared to the initial Zero Position Zone 151. The size of the decreased Zero Position Zone 150 can be defined by setting its radius to a fixed value, e.g., zero_position_zone:=0.7 in block 807. An average value of the current actual position 130 can be set as a new center of the decreased Zero Position Zone 150.

In case the query of block 806 returns a result different from a virtual zero position (0,0), this is an indication that the current actual position 130 is located outside the initial Zero Position Zone 151, which may happen if the operating element 110 is in an actuated state. In this case, the self-recalibration proceeds by returning to block 802. The subsequent process steps are the same as discussed above. If the self-recalibration process ends in block 807 with creating a decreased Zero Position Zone, it may be possible that the sensor device may end the self-recalibration process, e.g., it may go into a deep sleep mode. In other words, the sensor device may stop the self-recalibration process after a decreased Zero Position Zone with a fixed size is defined.

Additionally or alternatively, it may be possible that the sensor device may perform a subsequent self-re calibration step, for instance after a certain time span, e.g., after two or three days. In this case, the sensor device may be configured to perform the self-recalibration iteratively. In a first calibration step at a first time instant t₁, the sensor device may set a first current actual position 130₁ of the operating element 110 as a first mechanical zero position 1331, and to define the first mechanical zero position 133₁ as a center of a first Zero Position Zone 150₁, as discussed above.

At a second time instant t₂ the sensor device may then perform a subsequent second calibration step, wherein the sensor device may set a second current actual position 130₂ of the operating element 110 as a second mechanical zero position 133₂, and to define the second mechanical zero position 133₂ as a center of an updated second Zero Position Zone 150₂ that may replace the first Zero Position Zone 150₁. It is possible that both the first Zero Position Zone 150₁ and the second Zero Position Zone 150₂ are decreased Zero Position Zones having a fixed size, as discussed above.

With the above discussed iterative approach, an adaptive adjustment of the size of any Zero position Zone can be performed. For example, the size of a Zero Position Zone can be adaptively and gradually decreased to a predetermined minimum size. As mentioned above, the size of a Zero Position Zone shall be as small as possible so that the user experiences a good haptic of the operating element 110.

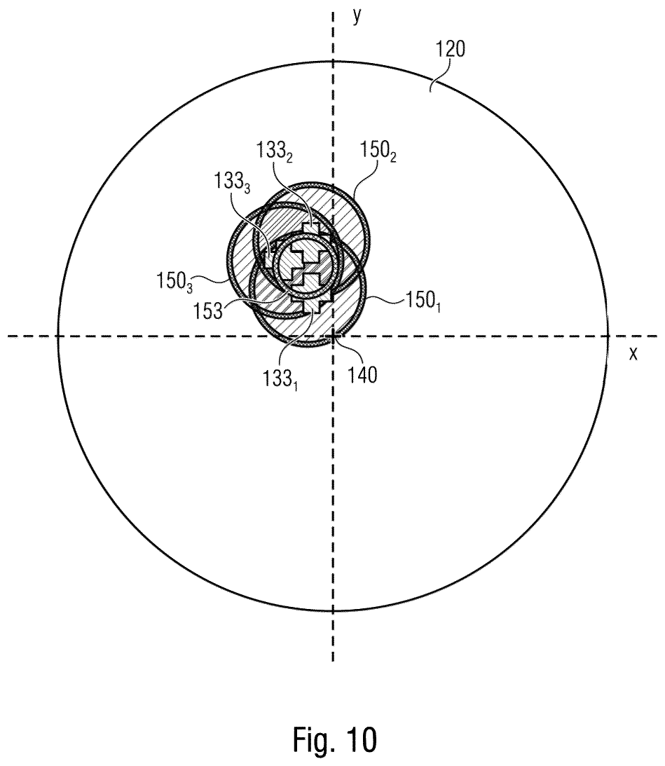

FIG. 10 shows a possible implementation of the innovative concept featuring an adaptive and gradual decrease of the size of a Zero Position Zone. This adaptive approach takes into account previous zero positions, thus reducing the Zero Position Zone to its utmost minimum.

With reference to FIG. 10, the sensor device may be configured to perform a plurality of consecutive calibration steps for creating a respective plurality of Zero Position Zones, as discussed above. For example, the sensor device may create a first Zero Position Zone 150₁, a second Zero Position Zone 150₂ and a third Zero Position Zone 150₃. As also mentioned above, in each calibration step, a current actual position 130 of the operating element 110 may be set as a new mechanical zero position 133 that defines a center of the corresponding Zero Position Zone 150. Accordingly, as exemplarily shown in FIG. 10, the sensor device may store a respective plurality of mechanical zero positions 133₁, 133₂, 133₃ belonging to each of the plurality of Zero Position Zones 150₁, 150₂, 150₃.

Then, the sensor device may create a minimized Zero Position Zone 153 having a radius that includes each of the previously stored mechanical zero positions 133₁, 133₂, 133₃, wherein the size of the minimized Zero Position Zone 153 is smaller than the size of each one of the plurality of previously created Zero Position Zones 150₁, 150₂, 150₃. The size of the minimized Zero Position Zone 153 can be slightly increased in order to compensate for an intrinsic sensor noise. With this iterative approach, however, the size of any Zero Position Zone can be reduced to its utmost minimum.

However, it may happen that a current actual position 130 of the operating element 110 in its non-actuated state is located outside the minimized Zero Position Zone 153, for example due to mechanical displacement causing a shift in the center hysteresis. In this case, the sensor device may discard the minimized Zero Position Zone 153 and resume the self-recalibration with one of the previously used decreased Zero Position Zones 150₁, 150₂, 150₃.

In other words, if the sensor device determines in a subsequent calibration step, after having created the minimized Zero Position Zone 153, that a current actual position 130 of the operating element 110 is located outside the minimized Zero Position Zone 153, then the sensor device may dismiss the minimized Zero Position Zone 153 and may create a new Zero Position Zone having a size that is larger than the size of the minimized Zero Position Zone 153. For example, the sensor device may then return to a new Zero Position Zone having a fixed size, for example, a decreased Zero Position Zone 150 as discussed above. For example, the sensor device may resume the self-recalibration with one of the previously used decreased Zero Position Zones 150₁, 150₂, 150₃.

Summarizing, the sensor device may perform the iterative approach for gradually decreasing the size of a Zero Position Zone by storing the center points 133₁, 133₂, 133₃ of previous recalibrations. Once a quantity of measurements exists, the minimized Zero Position Zone 153 may be created by determining a smallest circle containing all calibration points 133₁, 133₂, 133₃ and optionally adding some margin for the noise.

Up to now, the innovative concept has been discussed with reference to an operating element 110 being movable in a two-dimensional movement range, wherein a current actual position 130 of the operating element 110 was indicated by x-, y-coordinates. However, as mentioned in the beginning, the present innovative concept may also be employed in push buttons of electric tools, and the like.

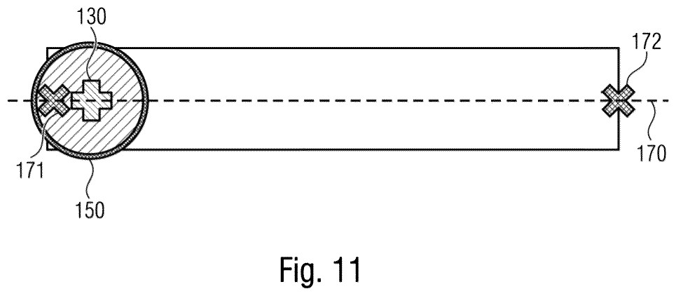

FIG. 11, shows an example of an operating element being provided as a push button (trigger) of a drilling machine. The push button may be pushed in order to activate the drilling machine, wherein the push button may only be pushed in one direction. Accordingly, the push button only makes a one-dimensional movement along an axis 170. This one-dimensional movement range 120 ranges from a mechanical start point 171 to a mechanical end stop 172. Ideally, a mechanical zero position of the push button shall coincide with the mechanical start point 171. Otherwise the drilling machine may start running even though the push button is not actuated by a user.

FIG. 11 shows a scenario in which a current actual position 130 of the push button deviates from the mechanical start point 171. In order to avoid the undesired activation of the drilling machine, the innovative self-recalibration mechanism may be employed, wherein a Zero Position Zone 150 may be created, as discussed above. The only difference may be that the current actual position 130 of the operating element may not be indicated by two-dimensional x-, y-coordinates but only by a one-dimensional x-coordinate.

Summarizing, the innovative concept provides a solution for a problem being related with a recalibration of hardware apparatuses for suppressing noisy behavior of operating elements (e.g., joysticks) in their zero position. A noisy behavior may originate from at least one of the sensor noise itself, mechanical tolerances on system level and abrasion/degradation. The innovative concept provides a solution by creating a Zero Position Zone to suppress the hysteresis effects as well as general noise. The size of the Zero Position Zone should be as small as possible to not realize it as customer. However, this introduces difficulties in initial calibration and transformation over time. The solution is an automated self-recalibration mechanism, that may be triggered in an adaptive, intelligent way.

The innovative concept extends the usable life span of a hardware apparatus. Less measurements are needed compared to conventional recalibration mechanisms, and averaging is not needed anymore.

The present innovative concept can be used in a wide variety of application fields, e.g., all kind of sensors (e.g., 3D Hall sensors) having a hysteresis effect or noise that needs to be suppressed, as well as on system level, where external factors introduce hysteresis or noise. A trigger that indicates a recalibration can be set depending on the application.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Some or all of the method steps may be executed by (or using) a hardware apparatus, like for example, a microprocessor, a programmable computer or an electronic circuit. In some implementations, one or more of the most important method steps may be executed by such an apparatus.

Depending on certain implementation requirements, implementations can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some implementations comprise a data carrier having electronically readable control signals, which are capable of cooperating with a programmable computer system, such that one of the methods described herein is performed.

Generally, implementations can be implemented as a computer program product with a program code, the program code being operative for performing one of the methods when the computer program product runs on a computer. The program code may for example be stored on a machine readable carrier.

Other implementations comprise the computer program for performing one of the methods described herein, stored on a machine readable carrier.

In other words, an implementation of the inventive method is, therefore, a computer program having a program code for performing one of the methods described herein, when the computer program runs on a computer.

A further implementation of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further implementation of the inventive method is, therefore, a data stream or a sequence of signals representing the computer program for performing one of the methods described herein. The data stream or the sequence of signals may for example be configured to be transferred via a data communication connection, for example via the Internet.

A further implementation comprises a processing means, for example a computer, or a programmable logic device, configured to or adapted to perform one of the methods described herein.

A further implementation comprises a computer having installed thereon the computer program for performing one of the methods described herein.

A further implementation comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some implementations, a programmable logic device (for example a field programmable gate array) may be used to perform some or all of the functionalities of the methods described herein. In some implementations, a field programmable gate array may cooperate with a microprocessor in order to perform one of the methods described herein. Generally, the methods are preferably performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

While this disclosure has been described with reference to illustrative implementations, this description is not intended to be construed in a limiting sense. Various modifications and combinations of the illustrative implementations, as well as other implementations of this disclosure, will be apparent to persons skilled in the art upon reference to the description. It is therefore intended that the appended claims encompass any such modifications or implementations.

### ASPECTS

The following provides an overview of some Aspects of the present disclosure:
Aspect 1: A hardware apparatus with a self-recalibration mechanism, the hardware apparatus comprising: a movable mechanical operating element configured to be moved by a user within a predetermined mechanical movement range; and a sensor device for determining a position of the movable mechanical operating element within the predetermined mechanical movement range wherein the sensor device is configured to perform a self-recalibration by: setting a current actual position of the movable mechanical operating element in a non-actuated state as a mechanical zero position, and setting a zero position zone extending around the mechanical zero position, wherein the sensor device is configured to treat all positions of the movable mechanical operating element that are located inside the zero position zone as virtual zero positions.
Aspect 2: The hardware apparatus according to Aspect 1, wherein the zero position zone is defined as a circular area with a radius extending around the mechanical zero position.
Aspect 3: The hardware apparatus according to any of Aspects 1-2, wherein the sensor device is configured to set a size of the zero position zone to a fixed value that covers different mechanical zero positions of the movable mechanical operating element that suffer from position deviations being caused by at least one of hysteresis, noise, or offsets.
Aspect 4: The hardware apparatus according to any of Aspects 1-3, wherein the sensor device is configured to set a size of the zero position zone to a fixed value that covers between 2% to 8% of a total movement range of the movable mechanical operating element.
Aspect 5: The hardware apparatus according to any of Aspects 1-4, wherein the sensor device is configured to perform an initial calibration step including creating an initial zero position zone, wherein a center of the initial zero position zone is located in a center of a total movement range of the movable mechanical operating element, and wherein the sensor device is configured to set a size of the initial zero position zone to a fixed value that covers between 20% to 30% of the total movement range of the movable mechanical operating element.
Aspect 6: The hardware apparatus according to Aspect 5, wherein the sensor device is configured to perform, after the initial calibration step, a subsequent calibration step, in which the sensor device is configured to: set a current actual position of the movable mechanical operating element, in the non-actuated state, as a new mechanical zero position, and set the new mechanical zero position as a center of a decreased zero position zone that is smaller than the initial zero position zone.
Aspect 7: The hardware apparatus according to Aspect 6, wherein the sensor device is configured to set a size of the decreased zero position zone to a fixed value that covers different mechanical zero positions of the movable mechanical operating element that suffer from position deviations being caused by at least one of hysteresis, noise, or offsets.
Aspect 8: The hardware apparatus according to Aspect 6, wherein the sensor device is configured to set a size of the decreased zero position zone to a fixed value that covers between 2% to 8% of the total movement range of the movable mechanical operating element.
Aspect 9: The hardware apparatus according to Aspect 6, wherein the sensor device is configured to check whether the current actual position of the movable mechanical operating element is located inside the decreased zero position zone, wherein the sensor device is configured to perform the check by: determining a radial distance of the current actual position from the center of the total movement range, and checking whether the radial distance is less than or equal to a radius of the decreased zero position zone.
Aspect 10: The hardware apparatus according to Aspect 9, wherein, if the sensor device determines that the current actual position of the movable mechanical operating element is located inside, or within a margin of, the decreased zero position zone, then the sensor device is configured to treat the current actual position of the movable mechanical operating element as a virtual zero position.
Aspect 11: The hardware apparatus according to Aspect 9, wherein, if the sensor device determines that the current actual position of the movable mechanical operating element is located outside the decreased zero position zone, then the sensor device is configured to subtract the radius of the decreased zero position zone from the actual current position of the movable mechanical operating element, such that a beginning of a movement of the movable mechanical operating element is only registered when the movable mechanical operating element leaves the decreased zero position zone.
Aspect 12: The hardware apparatus according to any of Aspects 1-11, wherein the sensor device is configured to perform the self-recalibration iteratively, wherein, in a first calibration step at a first time instant, the sensor device is configured to set a first current actual position of the movable mechanical operating element as a first mechanical zero position, and to define the first mechanical zero position as a center of a first zero position zone, and wherein, in a subsequent second calibration step at a second time instant, the sensor device is configured to set a second current actual position of the movable mechanical operating element as a second mechanical zero position, and to define the second mechanical zero position as a center of a second zero position zone.
Aspect 13: The hardware apparatus according to any of Aspects 1-12, wherein the sensor device is configured to: perform a plurality of consecutive calibration steps for creating a plurality of zero position zones, and to store a respective plurality of mechanical zero positions belonging to each of the plurality of zero position zones, and create a minimized zero position zone having a radius that includes each of the stored mechanical zero positions, wherein the size of the minimized zero position zone is smaller than the size of each one of the plurality of previously created zero position zones.
Aspect 14: The hardware apparatus according to Aspect 13, wherein, if the sensor device determines in a subsequent calibration step, after having created the minimized zero position zone, that a current actual position of the movable mechanical operating element in the non-actuated state is located outside the minimized zero position zone, then the sensor device is configured to dismiss the minimized zero position zone and to create a new zero position zone having a size that is larger than the size of the minimized zero position zone.
Aspect 15: The hardware apparatus according to any of Aspects 1-14, wherein the sensor device is configured to wait for a lapse of a predetermined period of time during which the movable mechanical operating element is in a non-actuated state, in order to ensure that the movable mechanical operating element is in the non-actuated state, before performing the self-recalibration, or wherein the sensor device is configured to wait for an occurrence of a predetermined event indicating that the movable mechanical operating element is in the non-actuated state before performing the self-recalibration.
Aspect 16: A method for performing a self-recalibration in a hardware apparatus, the method comprising: determining a position of an operating element that is movable by a user within a predetermined mechanical movement range; and performing the self-recalibration by: setting a current actual position of the operating element in a non-actuated state as a mechanical zero position; and setting a zero position zone extending around the mechanical zero position, wherein all positions of the operating element being located inside the zero position zone are treated as virtual zero positions.
Aspect 17: A non-transitory computer-readable storage medium having a computer program stored thereon, for performing, when being executed on a computer or a signal processor, a method for performing a self-recalibration, wherein the method comprises: determining a position of an operating element that is movable by a user within a predetermined mechanical movement range; and performing the self-recalibration by: setting a current actual position of the operating element in a non-actuated state as a mechanical zero position; and setting a zero position zone extending around the mechanical zero position, wherein all positions of the operating element being located inside the zero position zone are treated as virtual zero positions.

1. A hardware apparatus with a self-recalibration mechanism, the hardware apparatus comprising:
a movable mechanical operating element configured to be moved by a user within a predetermined mechanical movement range; and
a sensor device for determining a position of the movable mechanical operating element within the predetermined mechanical movement range
wherein the sensor device is configured to perform a self-recalibration by:
setting a current actual position of the movable mechanical operating element in a non-actuated state as a mechanical zero position, and
setting a zero position zone extending around the mechanical zero position,
wherein the sensor device is configured to treat all positions of the movable mechanical operating element that are located inside the zero position zone as virtual zero positions.

2. The hardware apparatus according to claim 1, wherein the zero position zone is defined as a circular area with a radius extending around the mechanical zero position.

3. The hardware apparatus according to claim 1, wherein the sensor device is configured to set a size of the zero position zone to a fixed value that covers different mechanical zero positions of the movable mechanical operating element that suffer from position deviations being caused by at least one of hysteresis, noise, or offsets.

4. The hardware apparatus according to claim 1, wherein the sensor device is configured to set a size of the zero position zone to a fixed value that covers between 2% to 8% of a total movement range of the movable mechanical operating element.

5. The hardware apparatus according to claim 1,
wherein the sensor device is configured to perform an initial calibration step including creating an initial zero position zone,
wherein a center of the initial zero position zone is located in a center of a total movement range of the movable mechanical operating element, and
wherein the sensor device is configured to set a size of the initial zero position zone to a fixed value that covers between 20% to 30% of the total movement range of the movable mechanical operating element.

6. The hardware apparatus according to claim 5, wherein the sensor device is configured to perform, after the initial calibration step, a subsequent calibration step, in which the sensor device is configured to:
set a current actual position of the movable mechanical operating element, in the non-actuated state, as a new mechanical zero position, and
set the new mechanical zero position as a center of a decreased zero position zone that is smaller than the initial zero position zone.

7. The hardware apparatus according to claim 6, wherein the sensor device is configured to set a size of the decreased zero position zone to a fixed value that covers different mechanical zero positions of the movable mechanical operating element that suffer from position deviations being caused by at least one of hysteresis, noise, or offsets.

8. The hardware apparatus according to claim 6, wherein the sensor device is configured to set a size of the decreased zero position zone to a fixed value that covers between 2% to 8% of the total movement range of the movable mechanical operating element.

9. The hardware apparatus according to claim 6,
wherein the sensor device is configured to check whether the current actual position of the movable mechanical operating element is located inside the decreased zero position zone,
wherein the sensor device is configured to perform the check by:
determining a radial distance of the current actual position from the center of the total movement range, and
checking whether the radial distance is less than or equal to a radius of the decreased zero position zone.

10. The hardware apparatus according to claim 9, wherein,
if the sensor device determines that the current actual position of the movable mechanical operating element is located inside, or within a margin of, the decreased zero position zone,
then the sensor device is configured to treat the current actual position of the movable mechanical operating element as a virtual zero position.

11. The hardware apparatus according to claim 9, wherein,
if the sensor device determines that the current actual position of the movable mechanical operating element is located outside the decreased zero position zone,
then the sensor device is configured to subtract the radius of the decreased zero position zone from the actual current position of the movable mechanical operating element, such that a beginning of a movement of the movable mechanical operating element is only registered when the movable mechanical operating element leaves the decreased zero position zone.

12. The hardware apparatus according to claim 1, wherein the sensor device is configured to perform the self-recalibration iteratively,
wherein, in a first calibration step at a first time instant, the sensor device is configured to set a first current actual position of the movable mechanical operating element as a first mechanical zero position, and to define the first mechanical zero position as a center of a first zero position zone, and
wherein, in a subsequent second calibration step at a second time instant, the sensor device is configured to set a second current actual position of the movable mechanical operating element as a second mechanical zero position, and to define the second mechanical zero position as a center of a second zero position zone.

13. The hardware apparatus according to claim 1, wherein the sensor device is configured to;
perform a plurality of consecutive calibration steps for creating a plurality of zero position zones, and to store a respective plurality of mechanical zero positions belonging to each of the plurality of zero position zones, and
create a minimized zero position zone having a radius that includes each of the stored mechanical zero positions, wherein the size of the minimized zero position zone is smaller than the size of each one of the plurality of previously created zero position zones.

14. The hardware apparatus according to claim 13, wherein,
if the sensor device determines in a subsequent calibration step, after having created the minimized zero position zone, that a current actual position of the movable mechanical operating element in the non-actuated state is located outside the minimized zero position zone,
then the sensor device is configured to dismiss the minimized zero position zone and to create a new zero position zone having a size that is larger than the size of the minimized zero position zone.

15. The hardware apparatus according to claim 1,
wherein the sensor device is configured to wait for a lapse of a predetermined period of time during which the movable mechanical operating element is in a non-actuated state, in order to ensure that the movable mechanical operating element is in the non-actuated state, before performing the self-recalibration, or
wherein the sensor device is configured to wait for an occurrence of a predetermined event indicating that the movable mechanical operating element is in the non-actuated state before performing the self-recalibration.

16. A method for performing a self-recalibration in a hardware apparatus, the method comprising:
determining a position of an operating element that is movable by a user within a predetermined mechanical movement range; and
performing the self-recalibration by:
setting a current actual position of the operating element in a non-actuated state as a mechanical zero position; and
setting a zero position zone extending around the mechanical zero position, wherein all positions of the operating element being located inside the zero position zone are treated as virtual zero positions.

17. A non-transitory computer-readable storage medium having a computer program stored thereon, for performing, when being executed on a computer or a signal processor, a method for performing a self-recalibration, wherein the method comprises:
determining a position of an operating element that is movable by a user within a predetermined mechanical movement range; and
performing the self-recalibration by:
setting a current actual position of the operating element in a non-actuated state as a mechanical zero position; and
setting a zero position zone extending around the mechanical zero position, wherein all positions of the operating element being located inside the zero position zone are treated as virtual zero positions.
